(19) United States
(12) Patent Application Publication
(10) Pub. No.: US 2020/0370150 A1
(43) Pub. Date: Nov. 26, 2020

(54) CARBIDE INSERT

(71) Applicant: BOEHLERIT GmbH & Co.KG., Kapfenberg (AT)

(72) Inventors: Margarethe TRAXLER, Graz (AT); Ronald WEISSENBACHER, Bruck an der Mur (AT)

(73) Assignee: BOEHLERIT GmbH & Co.KG., Kapfenberg (AT)

(21) Appl. No.: 16/881,311

(22) Filed: May 22, 2020

(30) Foreign Application Priority Data
May 23, 2019 (AT) A50476/2019

(51) Int. Cl. C22C 29/08; A01B 15/02; C22C 29/00

(52) U.S. Cl. CPC C22C 29/08; C22C 29/005; A01B 15/02

(57) ABSTRACT

A carbide insert for a soil tillage implement for agriculture, which is formed using or from at least one hard material and at least one binding metal. Iron is provided as a binding metal.

### CROSS-REFERENCE TO RELATED APPLICATIONS

The present application claims priority under 35 U.S.C. § 119(a) of Austria Patent Application No. A 50476/2019 filed May 23, 2019, the disclosure of which is expressly incorporated by reference herein in its entirety.

### BACKGROUND

### 1. Field of the Invention

The invention relates to a carbide insert for a soil tillage implement for agriculture, which is formed using or from at least one hard material and at least one binding metal.

Furthermore, the invention relates to the use of such a carbide insert.

### 2. Discussion of Background Information

Tillage implements for agriculture, which are made of steel, are known in the prior art. In recent times, there has been a move to equip corresponding parts made of steel with inserts made of carbide in order to extend the service life of a correspondingly used part. Carbide inserts initially increase the total costs at first glance, but it has been shown that by equipping soil tillage implements for agriculture or components therefor with carbide inserts, a service life can be increased to such an extent that ultimately the additional costs incurred at the beginning can be more than compensated for.

Carbide inserts for soil tillage implements and/or components or individual parts for such implements, which in turn are attached to an agricultural machine or device, can theoretically be composed in principle like carbide inserts for machining operations in metalworking.

Various types of carbides have become accepted for machining operations, which in addition to the hard materials used, a binding metal, an average grain size of the hard material(s), a ratio of the proportions by weight and, if appropriate, also a coating, comprise various parameters and variables which are oriented towards the respective intended use.

Carbides that contain cobalt as a binding metal have proven particularly useful in machining operations. Attempts have also been made to partially replace cobalt with other binding metals, in particular with nickel and/or iron. In principle, however, cobalt is still the most useful binding metal for machining used carbide inserts.

### SUMMARY

The object of the invention is to specify a carbide insert of the type mentioned at the outset, which is preferably suitable for use in soil tillage implements for agriculture, including components for such soil tillage implements.

Furthermore, it is an object of the invention to specify a use of a carbide insert.

The object of the invention is achieved when iron is provided as a binding metal in a carbide insert of the type mentioned at the outset.

An advantage achieved with the invention can be seen, in particular, in the fact that it was recognized that it is entirely sufficient to exclusively or at least partly provide iron as the binding metal for agricultural applications. Iron is mainly or exclusively provided as the binding metal in a carbide insert according to the invention. Production-related impurities of cobalt, which cannot be completely eliminated when the required binding metal iron is recovered, can, however, be present within the scope of the invention. According to the invention, however, this proportion of cobalt is not more than 0.20 percent by weight (hereinafter: % by weight), preferably less than 0.10% by weight, particularly preferably less than 0.08% by weight. The binding metal is therefore cobalt-free, apart from manufacture-related impurities of cobalt.

In the context of the invention, it was recognized in particular that it may already be sufficient to exclusively use iron as the binding metal for applications in the agricultural sector. When only iron is used as a binding metal, apart from manufacture-related impurities, as mentioned, a carbide or a carbide insert is obtained which is less break-resistant in comparison with cobalt as a binding metal. However, this is not important in the agricultural sector. Thus, the cobalt itself, which is questionable in terms of the environment, but also a health hazard, can be replaced by iron.

In addition, iron as a binding metal offers the advantage in that corresponding carbide inserts can be soldered very well, for example, on components of a soil tillage implement. This not only facilitates the production of components or soil tillage implements having such carbide inserts, but also allows farmers to carry out repair measures relatively easily on site and to be able to become active themselves when individual carbide inserts are worn out.

A further advantage is that abrasion of the carbide inserts is ecologically harmless when used in a soil tillage implement. This is not the case for cobalt.

The hard material is preferably a carbide of a metal selected from the group consisting of tungsten, titanium, vanadium, chromium, niobium and/or molybdenum. The carbide is preferably a tungsten carbide. In this preferred variant, provision can also be made for a part of the tungsten carbide to be replaced by titanium carbide, and possibly also another carbide of one of the metals mentioned. The hard material or the carbide is preferably provided in the carbide in a proportion of 75% by weight to 95% by weight, preferably 78% by weight to 94% by weight, in particular 80% by weight to 93% by weight. The higher the proportion of hard material, the harder and more wear-resistant is the carbide insert. On the other hand, higher strength values entail lower toughness. A balanced compensation for the intended application can be found in this respect. It has proven to be suitable for this when a proportion of binding metal is 6% by weight to 25% by weight, preferably 8% by weight to 22% by weight, in particular 10% by weight to 20% by weight. This enables an optimal balance between the required wear resistance on the one hand and an environmentally friendly carbide insert on the other. Higher iron levels lead to the carbide insert being inclined to break out, but this does not play a decisive role in the agricultural sector, unlike in the machining of metal workpieces such as crankshafts. While agricultural cultivation basically requires a relatively rough structuring and/or cutting of soil, the highest precision is required for a machining operation of metal workpieces such as crankshafts. However, this is not necessary in agricultural cultivation, which is why higher iron contents can be used. In addition, iron is significantly more environmentally friendly than cobalt and already occurs in a noticeably higher proportion in the soil to be cultivated.

Although it is sufficient to provide iron as the sole binding metal, nickel and/or chromium can also be present as components of the binding metal in addition to iron. Iron, however, remains the largest proportion of binding metal. A total proportion of nickel and chromium is a maximum of 4% by weight. Corrosion resistance can be increased by an admixture of more than 0.15% by weight up to a total of a maximum of 4% by weight of nickel and/or chromium, which is advantageous for maximizing the service life.

Although not absolutely necessary, a coating can be provided on the carbide insert in part or over the entire surface. The coating can be deposited in particular by chemical vapor deposition (CVD) and/or physical vapor deposition. The coating can, for example, be a coating of the AITiN type. Other coatings such as using or made of AlCrN are also possible. Alternating coating systems constructed of several layers are also possible. The layers can be arranged alternately, for example, layers made of AlTiN and AlCrN, which are arranged alternately, for example, having a thickness of up to 1 μm each. It is also possible that only a single coating layer is provided, which can optionally be sealed off with a cover layer. For example, the cover layer can consist of Al₂O₃. The layer arranged underneath can consist of AlCrN, for example. Regardless of the respective coating system, it is preferably provided that a total thickness of the coating is overall up to 15 μm, preferably 2 μm to 12 μm, in particular 3 μm to 8 μm.

In accordance with the advantages presented above, a carbide insert according to the invention is preferably used for a soil tillage implement for agriculture, in particular for the cultivation of agricultural areas. Tillage equipment for agriculture is to be understood broadly in this context. This means that this can be a machine or device that can already be used as such for agricultural applications. However, it can also be a component that is attached, for example, as a replaceable part to a larger device such as a plow or the like.

In accordance with the advantages set out above, the solution to the further object is that a carbide insert according to the invention is used for a soil tillage implement for agriculture. In turn, the soil tillage implement as a whole can be a device as such, for example, a plow, but can also be a component that is attached to an agricultural machine, for example, a cultivator blade.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

Further features, advantages and effects of the invention result from the exemplary embodiment illustrated below.

FIG. 1 shows a cultivator blade.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

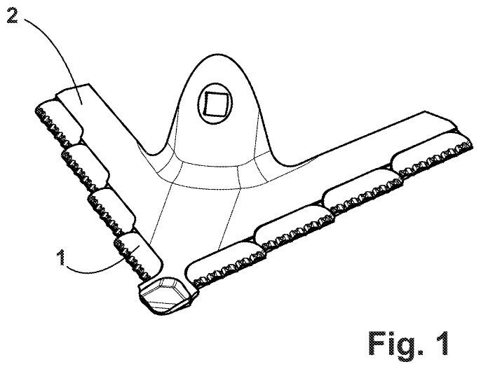

A cultivator blade 2 is illustrated in FIG. 1. The cultivator blade 2 has a plurality of carbide inserts 1. Each of these carbide inserts 1 is made up of a hard material, namely tungsten carbide, and a binding metal. The proportion of tungsten carbide is, for example, 85% by weight. The proportion of the binding metal is, for example, 10% by weight or 15% by weight. The binding metal is iron. An average grain size of the tungsten carbide, which can optionally be partially replaced by titanium carbide, is, for example, 4.5 μm to 5.6 μm. However, finer types of carbide can also be used. The hardness (HV30) is around 1550 to 1650 and the density around 14.25 gcm⁻³ having a binding metal content of iron as an exclusive binding metal and an average grain size of the tungsten carbide.

In use, it has been shown that carbide inserts 1 according to the invention having iron as a binding metal have approximately the same service lives as those with cobalt in a cultivator blade 2 as shown in FIG. 1. In comparison, however, it should be noted that abrasion of the carbide insert 1 and thus also of the binding metal is considerably less hazardous, since iron can readily be taken up in the soil, whereas cobalt acts as a contaminant in the soil and in particular can get into the food chain. Although outbreaks cannot be avoided even with high iron contents and the associated toughness, this does not play a significant role in soil tillage, unlike in the high-precision machining of metal workpieces. In this respect, the use of iron as a binding metal for carbide inserts 1 for soil tillage implements for agriculture results in an optimized field of application of carbides, which are formed exclusively or at least predominantly with iron as a binding metal and free of cobalt.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A carbide insert for a soil tillage implement for agriculture, which is formed using or from at least one hard material and at least one binding metal, wherein iron is provided as the binding metal.

2. The carbide insert according to claim 1, wherein the hard material is a carbide of a metal selected from the group consisting of tungsten, titanium, vanadium, chromium, niobium and/or molybdenum.

3. The carbide insert according to claim 1, wherein the hard material is formed from tungsten carbide and optionally titanium carbide.

4. The carbide insert according to claim 1, wherein the hard material is present in the carbide in a proportion of 75% by weight to 95% by weight, preferably 78% by weight to 94% by weight, in particular 80% by weight to 93% by weight.

5. The carbide insert according to claim 1, wherein the proportion of binding metal is 6% by weight to 25% by weight, preferably 8% by weight to 22% by weight, in particular 10% by weight to 20% by weight.

6. The carbide insert according to claim 1, wherein a coating is provided on the carbide insert.

7. The carbide insert according to claim 1, wherein the hard material has an average grain size of 0.5 μm to 10 μm, preferably 0.6 μm to 8 μm, in particular 0.7 μm to 1.5 μm.

8. The carbide insert according to claim 1, wherein in addition to iron, nickel and/or chromium are present as constituents of the binding metal.

9. The carbide insert according to claim 8, wherein nickel and/or chromium are present individually or together, wherein a total proportion of nickel and chromium is at most 4% by weight.

10. A soil cultivation implement for agriculture, in particular for the preparatory cultivation of agricultural areas, having a carbide insert according to claim 1.

11. A use of a carbide insert according to claim 1 for a soil tillage implement for agriculture.
